(19) United States
(12) Patent Application Publication
(10) Pub. No.: US 2002/0084297 A1
(43) Pub. Date: Jul. 4, 2002

(54) Configurable roof rack system

(76) Inventors: Bruce Preston Williams, Grosse Pte. Pk., MI (US); Gordon Platto, Troy, MI (US); John Kyungwook Kim, Detroit, MI (US)

Correspondence Address: KEVIN G. MIERZWA, ARTZ & ARTZ, P.C., 28333 TELEGRAPH ROAD, SUITE 250, SOUTHFIELD, MI, 48034, US

(21) Appl. No.: 09/682,594

(22) Filed: Sep. 25, 2001

Related U.S. Application Data
(60) Provisional application No. 60/259,005, filed on Dec. 29, 2000.

(51) Int. Cl. B60R 9/042

(52) U.S. Cl. 224/310; 224/324; 224/325

(57) ABSTRACT

A roof rack system 10 is provided, including at least one storage surface 20 movable between a first position 22 and a second position 24. The first position 22 is defined by the at least one storage surface 20 being generally coincident with a roof 14 of a vehicle 12. The second position 24 is defined by the at least one storage surface 20 being generally coincident with a side 16 of a vehicle 12.

### CROSS REFERENCE TO RELATED APPLICATIONS

This application claims priority from U.S. Provisional Patent Application Serial No. 60/259,005 filed on Dec. 29, 2000.

### BACKGROUND OF INVENTION

The present invention relates generally to an automotive roof rack system and more particularly to an automotive roof rack system with increased functionality.

Considerable effort has been exhausted by automotive engineers in an attempt to increase the utility of modern automotive designs. Although mere transportation of occupants still remains a primary objective, the modern automotive vehicle is often designed to provide a greater range of utilities. Design considerations such as customer convenience, ease of use, and increased functionality contribute significant impetus into the ever-evolving automotive designs. One particular area of designs requiring such considerations, and important to the increased utility of the vehicle, is the area of vehicle storage capacity.

Improvements to vehicle storage capacity have taken on a wide variety of forms. One set of improvements has led to an increase in storage capacity within the vehicle compartment. Although vehicles such as SUVs and minivans may provide such increased storage within the vehicle compartment, vehicle owners often prefer to utilize this space to increase passenger occupant capacity rather than for storage. Other, and possibly more traditional, storage techniques utilize separate compartments often positioned in the rear of the vehicle. These areas, commonly referred to as trunks, provide storage isolated from the passenger compartment. The size of these compartments as well as the presence of a deck lid, however, often prevents their use for storage and transporting oversized objects. There is, therefore, often a need to store and transport oversized objects or a large quantity of objects without interfering with passenger occupancy areas. This ability is commonly not afforded by trunk space.

One traditional approach to providing such storage has been through the use of a roof rack. The use of roof racks dates back considerably in the history of automotive design. Their use allows occupants to store and transport objects on the roof of the vehicle without interfering with passenger occupancy and without the limitations of common trunk designs. Although their position on the roof of the vehicle can provide occupants with considerably storage, their very position often proves detrimental to the accessibility necessary to load and unload the stowed items. The advent of larger vehicles such as SUVs, vans, and minivans has exacerbated the accessibility problems often associated with present roof rack designs. Even relatively tall individuals can have difficulty loading and unloading roof racks on such large vehicles. An improvement to the accessibility of roof rack systems would be highly beneficial and would serve to increase consumer convenience and satisfaction.

In addition to problems arising involving accessibility, present roof rack systems can suffer from additional limitations. Often, a roof rack structure designed to accommodate the storage of smaller items may prove incompatible with the storage of larger items such as kayaks, bikes, and other large objects. One standard approach to the storage of small items has been the formation of a basket within the roof rack system. Although these baskets have proven highly convenient, it is also known that they can interfere with the mounting of larger storage items to the roof rack system. One solution has been to provide basket systems that may be mounted and unmounted from the roof rack system. This commonly requires assembly and disassembly procedures that can reduce the convenience of the roof rack system. In addition, removal of portions of the roof rack system may require storage of rack parts and, therefore, may be impractical in some scenarios. A more flexible roof rack system that could accommodate both small and large storage objects without requiring disassembly of the roof rack system would be highly beneficial. It would, therefore, be highly desirable to have a roof rack system with improved accessibility and increased flexibility to accommodate both large and small storage objects.

### SUMMARY OF INVENTION

It is, therefore, an object of the present invention to provide an automotive roof rack system with improved accessibility and improved flexibility.

In accordance with the objects of the present invention, an automotive roof rack system is provided. The automotive roof rack system includes at least one storage surface having a first position, generally coincident to the roof of the vehicle, and a second position, generally coincident to the side of the vehicle. The at least one storage surface is movable between the first position and the second position to provide an automotive roof rack system with improved accessibility and increased flexibility.

Other objects and features of the present invention will become apparent when viewed in light of the detailed description of the preferred embodiment when taken in conjunction with the attached drawings and appended claims.

### BRIEF DESCRIPTION OF DRAWINGS

FIG. 1 is an illustration of an automotive roof rack system in accordance with the present invention, the roof rack system shown in a stored first position;

FIG. 2 is an illustration of an embodiment of an automotive roof rack system in accordance with the present invention, the automotive roof rack system shown in a deployed second position; and

FIG. 3 is an illustration of an embodiment of an automotive roof rack system in accordance with the present invention, the automotive roof rack system shown in an alternate deployed position; and

FIG. 4 is an illustration of an embodiment of an automotive roof rack in accordance with the present invention, the automotive roof rack system shown in a collapsed position.

### DETAILED DESCRIPTION

Referring now to FIG. 1 which is an illustration of an embodiment of a roof rack system 10 in accordance with the present invention. The roof rack system 10 is intended for use on an automobile 12 having a roof portion 14 and a side portion 16. Although the roof rack system 10 is illustrated in a particular position in configuration on the automobile 12, it should be understood that a wide variety of positions and configurations are contemplated by the present invention.

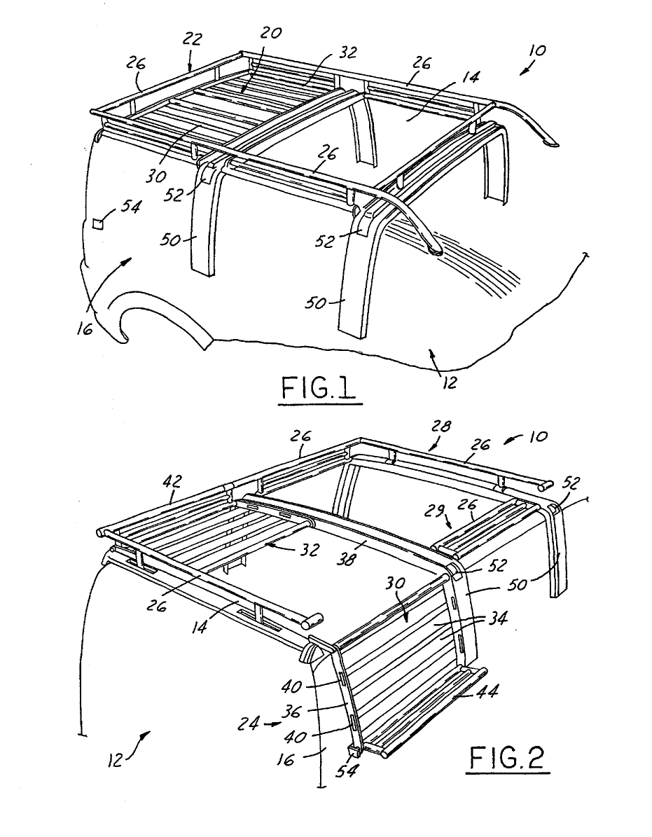

The roof rack system 10 includes at least one storage surface 20. The use of a storage surface 20 for mounting objects for transport is well known in the prior art. The at least one storage surface 20 is movable between a first position 22, where the at least one storage surface 20 is generally coincident to the roof portion 14 of the automobile 12, and a second position 24 (see FIG. 2), where the at least one storage surface 20 is generally parallel to the side portion 16 of the automobile 12. The capability of moving the at least one storage surface 20 from the first position 22 to the second position 24 provides a variety of benefits.

One set of benefits realized by the present invention involves accessibility of the roof rack system 10. In the prior art, when a storage surface was positioned on the roof portion 14 of the automobile 12, it was often difficult for many users to access the storage area due to the height of the vehicle 12. Often users were required to balance themselves within door frames or on tailgates in an effort to reach the roof portion 14. Even then, often portions of the storage surface 20 would be out of the reach of some users. The present invention improves upon on the accessibility of these designs by having a storage surface 20 that is movable between the first position 22 and the second position 24. Objects may be attached and detached from the at least one storage surface 20 while the at least one storage surface 20 is in the second position 24, allowing convenient and easy access to the at least one storage surface 20 from the side of the vehicle. The at least one storage surface 20 may then be moved back into the first position 22 for transport. In another scenario, the at least one storage surface 20 may be left in the second position 24 during transport. This provides a convenient mounting surface for oversized objects to be secured onto the side of the vehicle during transport. This further improves on accessibility since heavy and oversized objects need not be lifted to the height of the roof portion 14 of the vehicle 12 but only to the height of the side portion 16.

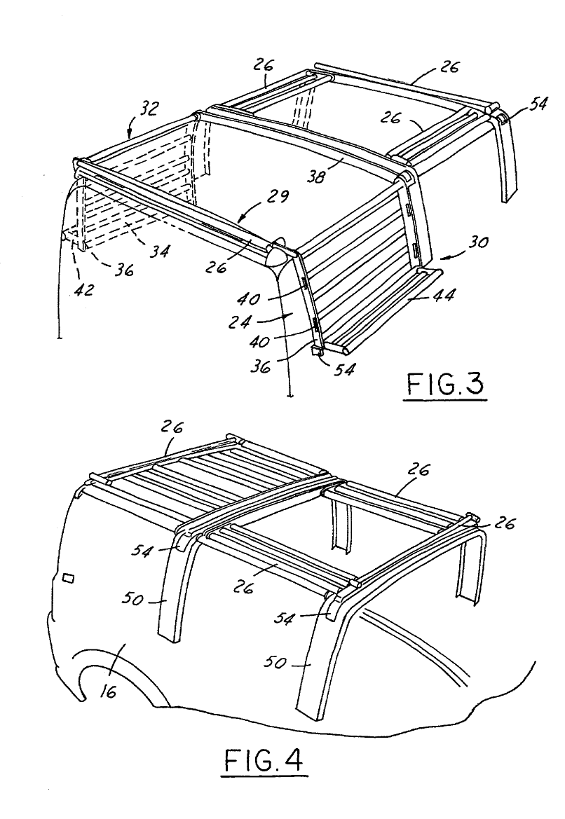

In addition to the improvements in accessibility, the present invention provides flexibility of use not often found in present roof rack designs. As has been discussed, the present invention can provide more storage on the side portion of the vehicle 16 as well as the roof portion 14. Additionally, by moving the at least one storage surface 20 from the first position 22 to the second position 24, the roof rack system 10 may be more suitable for the mounting of oversized objects, such as skis, boats, or bikes, on the roof portion 14 of the automobile 12. In one embodiment, the roof rack system 10 further includes a plurality of collapsible rails 26. The plurality of collapsible rails 26 when in the raised position 28 provide basket style support for objects mounted on the at least one storage surface 20 (see FIG. 1). When the plurality of collapsible rails 26 are moved into the collapsed position 29 and the at least one storage surface 20 is moved into the second position 24 (see FIG. 3), the roof portion 14 of the automobile 12 is cleared of any obstructions that may interfere with the mounting of oversized objects to the roof 14 of the vehicle 12. In this scenario, the at least one storage surface 20 is moved into the second position 24 to provide additional storage on the side portion 16 of the vehicle 12 while the roof portion 14 is cleared for oversized objects. In an alternate embodiment, the at least one storage surface 20 may be left in the first position 22 and the plurality of collapsible rails 26 may be folded down to provide a roof portion 14 cleared of obstructions (see FIG. 4).

Although the roof rack system 10 has thus far been described generically, it is contemplated that the roof rack system 10 may be formed in a variety of specific embodiments. In one such embodiment, the at least one storage surface 20 includes a right storage surface 30 and a left storage surface 32. Although the left storage surface 32 and the right storage surface 30 may be formed in a variety of fashions, in one embodiment, they include a plurality of slat elements 34 positioned mounted between track elements 36. The track elements 36 travel along guide elements 38 to allow the storage surface 20 to move from the first position 22 into the second position 24. The track elements 36 may also include securing slots 40 to provide fastening points for securing objects to the storage surface 20.

The roof rack system 10 may additionally include a left end rail element 42 and a right end rail element 44 mounted on the left storage surface 32 and the right storage surface 30, respectively. The left end rail element 42 and the right end rail element 44 serve a dual purpose. When the storage surface 20 is in the first position 22, the left end rail element 42 and the right end rail element 44 are positioned in conjunction with a plurality of collapsible rails 26 to form a basket 46 on the roof portion 14 of the vehicle 12. The basket 46 helps retain objects stored on the roof portion 14 of the vehicle 12 during transportation. Additionally, when the storage surface 20 is in the second position 24, the left end rail element 42 and the right end rail element 44 can serve as a base support for objects mounted on the side portion 16 of the vehicle. In other embodiments, however, the left end rail element 42 and the right end rail element 44 may be collapsed onto the storage surface 20 when in the second position 24 to minimize the width profile of the automobile 12.

The roof rack system 10 may further include a plurality of mounting elements 50. Although a variety of configurations are contemplated, in one embodiment the use of three mounting elements 50 is contemplated. It is contemplated that the mounting elements 50 may include latching areas 52. The latching areas 52 may be utilized as a convenient location to attach bunge cords or other securing straps commonly utilized to hold objects on the roof rack system 10. The present invention may further include a locking mechanism 54 for securing the storage surface 20 in the second position 24. Although a variety of locking elements 54 are contemplated by the present invention, in one embodiment the locking element 54 is a pivoting lock that can remain flush with the side portion 16 of the vehicle 12 while the storage position 20 is in the first position 22 (see FIG. 1) and may be swung out to lock the storage surface 20 in the second position 24 (see FIG. 2).

While the invention has been described in connection with one of more embodiments, it is to be understood that the specific mechanisms and techniques which have been described are merely illustrative of the principles of the invention. Numerous modifications may be made to the methods and apparatus described without departing from the spirit and scope of the invention as described and defined by the appended claims.

1. A roof rack system comprising:
at least one storage surface movable between a first position and a second position;
said first position defined by said at least one storage surface being generally coincident with a roof of a vehicle; and
said second position defined by said at least one storage surface being generally coincident with a side of a vehicle.

2. A roof rack system as described in claim 1 further comprising:
a locking mechanism securing said at least one storage surface in said second position.

3. A roof rack system as described in claim 1 further comprising:
a plurality of collapsible rails.

4. A roof rack system as described in claim 1 further comprising:
at least one track element mounted to said at least one storage surface; and at least one guide element.

5. A roof rack system as described in claim 4 further comprising:
at least one securing slot formed in said at least one track element.

6. A roof rack system as described in claim 1 further comprising:
a right storage surface; and
a left storage surface.

7. A roof rack system as described in claim 6 further comprising:
a left end rail element attached to said left storage surface; and
a right end rail element attached to said right storage surface.

8. A roof rack system as described in claim 1 wherein said at least one storage surface includes a plurality of slat elements.

9. A roof rack system as described in claim 1 further comprising:
at least one mounting element.

10. A roof rack system as described in claim 9 further comprising: at least one latching area.

11. A roof rack system for mounting on a vehicle, including a vehicle roof, a vehicle right side and a vehicle left side, comprising:
a left storage surface moveable between a left first position, wherein said left storage surface is generally coincident with the vehicle roof, and a left second position, wherein said left storage surface is generally coincident with the vehicle left side; and
a right storage surface moveable between a right first position, wherein said left storage surface is generally coincident with the vehicle roof, and a right second position, wherein said right storage surface is generally coincident with the vehicle right side.

12. A roof rack system as described in claim 11 further comprising:
a right locking mechanism for securing said right storage surface in said right second position; and
a left locking mechanism for securing said left storage surface in said left second position.

13. A roof rack system as described in claim 11 further comprising:
a plurality of collapsible rails.

14. A roof rack system as described in claim 11 further comprising:
at least one right track element mounted to said right storage surface;
at least one left track element mounted to said left storage surface; and at least one guide element.

15. A roof rack system as described in claim 14 further comprising:
a plurality of securing slots formed in said at least one right track element and said at least one left track element.

16. A roof rack system as described in claim 11 further comprising:
a left end rail element attached to said left storage surface; and
a right end rail element attached to said right storage surface.

17. A roof rack system as described in claim 11 wherein said right storage surface includes a plurality of slat elements.

18. A roof rack system as described in claim 11 wherein said left storage surface includes a plurality of slat elements.

19. A roof rack system as described in claim 11 further comprising:
a plurality of mounting elements.

20. A roof rack system as described in claim 19 further comprising:
a plurality of latching areas formed in said plurality of mounting elements.

21. A roof rack system for use on a roof of a vehicle comprising:
a plurality of collapsible rails movable between a raised position and a collapsed position, said plurality of collapsible rails forming a basket on the roof when in said raised position, and said plurality of collapsible rails allowing oversized objects to be mounted to the roof when in said collapsed position.

22. A roof rack system as described in claim 21 further comprising:
at least one storage surface positioned on the roof of the vehicle.

23. A roof rack system as described in claim 22 wherein said at least one storage surface is movable between a first position and a second position:
said first position defined by said at least one storage surface being generally coincident with the roof of the vehicle; and
said second position defined by said at least one storage surface being generally coincident with a side of the vehicle.
